(19) United States
(12) Patent Application Publication
(10) Pub. No.: US 2024/0165991 A1
(43) Pub. Date: May 23, 2024

(54) WHEEL DEVICE FOR MOBILE ROBOT CAPABLE OF DRIVING ON ROUGH TERRAIN AND OVERCOMING OBSTACLES, AND MOBILE ROBOT INCLUDING SAME

(71) Applicant: HOSEO UNIVERSITY ACADEMIC COOPERATION FOUNDATION, Chungcheongnam-do (KR)

(72) Inventor: Young Eun SONG, Chungcheongnam-do (KR)

(21) Appl. No.: 18/283,269

(22) PCT Filed: Mar. 23, 2022
(86) PCT No.: PCT/KR2022/004082

§ 371 Date: Sep. 21, 2023

(30) Foreign Application Priority Data
Mar. 24, 2021 (KR) 10-2021-0038133

(51) Int. Cl. B60B 19/00; B25J 5/00

(52) U.S. Cl. CPC B60B 19/003; B25J 5/007

(57) ABSTRACT

An omni-wheel device is capable of driving on both flat and stepped terrains. The omni-wheel device may include an omni-wheel segment of which an area in contact with the ground includes a portion of an omni-wheel, an actuator capable of moving the omni-wheel segment in the radial direction, and a wheel drum to which one end of the actuator is fixed and in which a rotation shaft is assembled at the center thereof.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2022/004082 filed on Mar. 23, 2022, which claims priority to the benefit of Korean Patent Application No. 10-2021-0038133 filed in the Korean Intellectual Property Office on Mar. 24, 2021, the entire contents of which are incorporated herein by reference.

### BACKGROUND

### 1 Technical Field

The present invention relates to a mobile robot capable of overcoming obstacles, and more specifically, to a wheel device for a mobile robot capable of driving on rough terrain and overcoming obstacles, and a mobile robot including the wheel device.

### 2. Background Art

In general, wheeled operating devices (automated guided vehicles (AGVs)), transportation means (automobiles), and robots can travel smoothly on a flat ground, but hardly overcome or cannot overcome obstacles such as a stair, an unpaved road, a bare land, a door sill, and a rough road.

Examples of the operating devices include Korean Utility Model Registration No. 20-0232858 (Wheelchair Belt Tire System) and Korean Unexamined Patent Publication No. 10-2009-0103357 (Wheelchair for Climbing Stair and Wheel Thereof).

In order to overcome these shortcomings, a caterpillar method was proposed. However, the caterpillar method has a complicated structure, has difficulties in high-speed driving, and is inefficient in maintenance due to the large number of components.

### SUMMARY

Hence, the present invention is conceived to solve the problems described above, and objects to be achieved by the present invention are to provide a wheel device for a mobile robot capable of driving on rough terrain such as an unpaved road, a hill-side road, and an outdoor land and overcoming obstacles such as a stair and a door sill, and a mobile robot including the same.

Other objects of the present invention are to provide a wheel device for a mobile robot and a mobile robot including the same, the wheel device being good at utilizing space inside the robot than conventional caster wheels by configuring front wheels and rear wheels with omni wheels.

However, technical objects to be achieved by the present invention are not limited to the technical objects mentioned above, and the following description enables still other unmentioned technical objects to be clearly understood by a person of ordinary skill in the art to which the present invention pertains.

In order to achieve a technical object described above, there is provided a wheel device for a mobile robot 100 capable of driving on rough terrain and overcoming obstacles, the wheel device including: a first omni wheel 200a provided in the mobile robot 100; a second omni wheel 200b provided in the mobile robot 100; a middle wheel 120 provided between the first omni wheel 200a and the second omni wheel 200b; wheel links 130 connecting the first omni wheel 200a and the middle wheel 120; a first suspension 140 connected between the mobile robot 100 and the wheel links 130; and a second suspension 150 connected between the mobile robot 100 and the wheel links 130 in the vicinity of the first suspension 140.

In addition, the first omni wheel 200a and the second omni wheel 200b may have five to ten omni wheel segments 210 which are arranged in a circumferential direction.

In addition, the first omni wheel 200a may be a driving wheel, and/or the middle wheel 120 may be a driving wheel.

In addition, the first and second suspensions 140 and 150 may be installed to be relatively rotatable with respect to the mobile robot 100 and the wheel links 130.

In addition, the first and second omni wheels 200a and 200b, the wheel links 130, and the first and second suspensions 140 and 150 may be provided on both respective sides of the mobile robot 100.

Another object of the present invention can be achieved by a mobile robot including the wheel device described above.

In addition, the mobile robot may be one of a logistics robot, an electric cart, an automated guided vehicle, and a wheelchair.

According to an embodiment of the present invention, the mobile robot can travel on rough terrain such as an unpaved road, a hill-side road, and an outdoor land and can overcome obstacles such as a stair and a door sill. This enables an efficient delivery to be achieved when the present invention is applied to a logistics robot.

In addition, by configuring the front and rear wheels as omni wheels, space utilization inside the robot is superior compared to a conventional caster wheel. Hence, the capacity of a battery can increase, or various components can be arranged.

In addition, application of the omni wheel enables driving and rotation in place or in a small space.

However, effects to be achieved by the present invention are not limited to the effects mentioned above, and the following description enables other unmentioned effects to be clearly understood by a person of ordinary skill in the art to which the present invention pertains.

### BRIEF DESCRIPTION OF THE DRAWINGS

The following drawings accompanied in this specification illustrate a preferred embodiment of the present invention and are provided to cause the technical idea of the present invention to be better understood with the detailed description of the invention to be described below, and thus the present invention is not to be construed by being limited only to illustration of the drawings.

FIG. 1 is a side view of a mobile robot 100 including a wheel device capable of driving on rough terrain and overcoming obstacles according to an embodiment of the present invention.

FIG. 2 is a perspective view of first and second omni wheels 200a and 200b illustrated in FIG. 1.

FIG. 3 is a side view illustrating a state in which the mobile robot 100 illustrated in FIG. 1 climbs an obstacle 60.

### DETAILED DESCRIPTION

Hereinafter, embodiments of the present invention will be described with reference to the accompanying drawings and in detail to the extent that a person with ordinary knowledge in the art to which the present invention pertains can easily implement the embodiments of the present invention. However, since the description of the present invention is provided for only an embodiment for describing structural or functional description, the scope of the claims of the present invention is not to be construed as limited by the embodiments described herein. That is, since the embodiment can be variously modified and can have various forms, the scope of the claims of the present invention is to be understood to include equivalents capable of realizing technical ideas. In addition, since objects or effects presented in the present invention do not mean that a specific embodiment is to include all of the objects or the effects or include only the effects, the scope of the claims of the present invention is not to be construed as limited thereby.

Meanings of terms provided herein are to be understood as follows.

Terms such as “first” and “second” are used to distinguish one configurational element from another configurational element, and the scope of the claims is not to be limited by these terms. For example, a first configurational element can be named as a second configurational element, and similarly, the second configurational element can also be named as the first configurational element. The description in which one configurational element is mentioned to be “connected to” another configurational element is to be understood to mean that the one configurational element can be directly connected to the other configurational element, or that still another configurational element can be present therebetween. On the other hand, the description in which one configurational element is “directly connected to” another configurational element is to be understood to mean that no configurational element is present therebetween. Meanwhile, the same is true of other expressions, that is, “between” and “directly between”, “adjacent” and “directly adjacent”, or the like for describing relationships between configurational elements.

An expression with a singular form is construed to include a meaning of a plural form thereof, unless obviously implied otherwise in context. Terms such as “comprise” or “have” are to be construed to specify that a feature, a number, a step, an operation, a configurational element, a member, or a combination thereof described herein is present and are not to exclude presence or a possibility of addition of one or more other features, numbers, steps, operations, configurational elements, members, or combinations thereof in advance.

Unless otherwise defined, all terms used herein have the same meanings as meanings generally understood by a person of ordinary skill in the art to which the present invention pertains. The same terms as those defined in a generally used dictionary are to be construed as having the same meanings as the contextual meanings in the related art. In addition, unless clearly defined in the present invention, the terms are not to be construed as having ideal or excessively formal meanings.

### Configurations of Embodiments

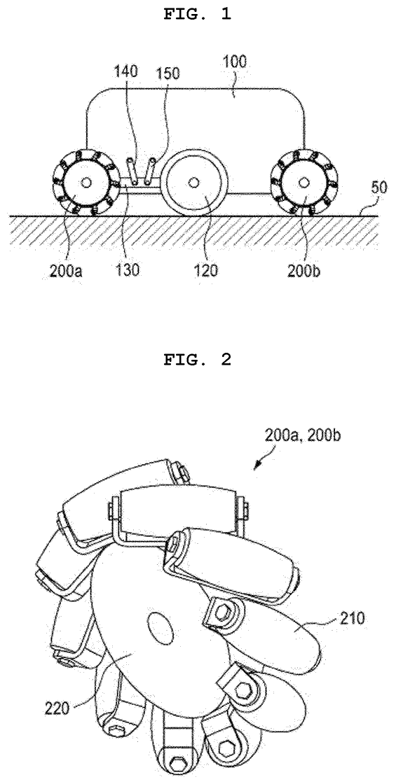

Hereinafter, configurations of preferred embodiments will be described in detail with reference to the accompanying drawings. FIG. 1 is a side view of a mobile robot 100 including a wheel device capable of driving on rough terrain and overcoming obstacles according to an embodiment of the present invention. As illustrated in FIG. 1, the mobile robot 100 is an example of an autonomous driving device. Examples of specific applications of the mobile robot 100 can include an electric cart, a wheelchair, an automated guided vehicle (AGV), and the like.

The mobile robot 100 has a pair of first omni wheels 200a at a front side. The first omni wheel 200a can be a driving wheel, and the pair of first omni wheels 200a can be rotated and steered independently. The pair of first omni wheels 200a can independently perform forward and reverse rotation. The pair of first omni wheels 200a are arranged to project more forward than the front of the mobile robot 100.

The mobile robot 100 has a pair of second omni wheels 200b at a rear side. The second omni wheel 200b can be a driving wheel, and the pair of second omni wheels 200b can be rotated and steered independently. The pair of second omni wheels 200b can independently perform forward and reverse rotation. The second omni wheels 200b can be driven in conjunction with the first omni wheels 200a. The pair of second omni wheels 200b are arranged to project more rearward than the rearmost part of the mobile robot 100.

A middle wheel 120 is positioned between the first and second omni wheels 200a and 200b and can be a driving wheel or an idle wheel.

The mobile robot 100 can be equipped with six wheels and driven by six servomotors (not illustrated), respectively. The number of wheels can be further increased as necessary. The servomotors can be mounted on a wheel link 130.

The wheel link 130 connects and supports the first omni wheels 200a and the middle wheel 120. One end of a first suspension 140 is rotatably connected to the mobile robot 100, and the other end thereof is rotatably connected to the wheel link 130. One end of a second suspension 150 is rotatably connected to the mobile robot 100, and the other end thereof is rotatably connected to the wheel link 130. The first and second suspensions 140 and 150 have respective internal dampers and springs to absorb an impact. The first and second suspensions 140 and 150 can be installed parallel to each other. Optionally, the second suspension 150 can be installed vertically, and the first suspension 140 can be installed to be inclined with respect to the second suspension 150 (for example, at an inclination angle of 10° to 30°).

FIG. 2 is a perspective view of the first and second omni wheels 200a and 200b illustrated in FIG. 1. As illustrated in FIG. 2, omni wheel segments 210 have an arcuate shape dividing the omni wheel 200 into 6 parts. A rotation shaft is assembled at a center of a wheel drum 220 to transmit torque. Six to ten omni wheel segments 210 are arranged in the circumferential direction of the wheel drum 220. Each of the omni wheel segment 210 has an arcuate shape formed by dividing a circle into six parts. Each of the omni wheel segments 210 is equipped with a roller at the outermost side thereof. The roller is made of rubber, a synthetic resin material (for example, urethane), or metal (for example, aluminum). The roller is installed to be inclined with respect to the circumferential direction and is rotatable.

### Operations of Embodiments

Hereinafter, operations of preferred embodiments will be described in detail with reference to the accompanying drawings. First, on a ground surface 50 of a flat ground as illustrated in FIG. 1, the pair of first and second omni wheels 200a and 200b and the middle wheel 120 are all rotated while being in contact with the ground surface 50. Examples of the ground surface 50 is a road of asphalt or concrete, a pedestrian path of a sidewalk block, an indoor corridor, a track, or the like. The first and second omni wheels 200a and 200b and the middle wheel 120 can be driven smoothly (for example, vibration-free, low-noise, slip-free driving) and steered. In particular, characteristics of the omni wheel 200 allow rotation to be freely performed in place or in a small space. At this time, the wheel link 130 is kept at a level posture, and the first and second suspensions 140 and 150 absorb an impact during driving.

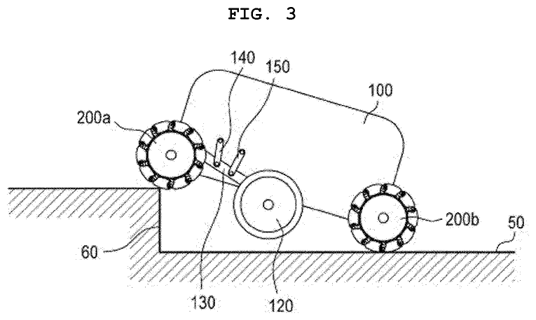

FIG. 3 is a side view illustrating a state in which the mobile robot 100 illustrated in FIG. 1 climbs an obstacle 60. As illustrated in FIG. 3, when the obstacle 60 such as a stair, a step, or a rough road is encountered, the first omni wheels 200a rotates while first coming into contact with the obstacle and lifts a front part of the mobile robot 100. At this time, while the wheel link 130 tilts, the middle wheel 120 can take off from the ground surface 50. The continuous driving of the first and second omni wheels 200a and 200b causes the front side of the mobile robot 100 to be gradually lifted. The first and second suspensions 140 and 150 absorb an impact generated during a collision with the obstacle 60 and gently support a tilt difference between the wheel link 130 and the mobile robot 100. Further, when the entire obstacle 60 is overcome, the mobile robot 100 and the wheel link 130 can return back to a horizontally parallel state due to a restoring force of the first and second suspensions 140 and 150. This process is the same for descending the obstacle 60.

The detailed descriptions of preferred embodiments of the present invention disclosed as described above have been provided such that it is possible for those skilled in the art to implement and realize the present invention. Although the descriptions have been provided with reference to the desirable embodiments of the present invention, it will be understood that those skilled in the art can variously modify and change the present invention within a range without departing from the scope of the present invention. For example, those skilled in the art can use each of the configurations described in the above-described embodiments in a way of combining the configurations with each other. Hence, the present invention is not intended to be limited to the embodiments illustrated herein, but to provide a maximum range consistent with the principles and novel features disclosed herein.

The present invention can be embodied into another specific example within a range without departing from the idea and the essential feature of the present invention. Hence, the detailed descriptions are not to be construed to be limited in any aspects but is considered as an exemplary example. The scope of the present invention is determined through reasonable interpretation of the accompanying claims, and any modifications within an equivalent scope of the present invention are included in the scope of the present invention. The present invention is not to be limited to the embodiments illustrated herein, but to provide a maximum range consistent with the principles and novel features disclosed herein. In addition, any claims that do not have an explicit dependent relationship in the claims can be combined to configure an embodiment or be included as new claims by amendment after filing the application.

The mobile robot can travel on rough terrain such as an unpaved road, a hill-side road, and an outdoor land and can overcome obstacles such as stairs and door sills. This enables an efficient delivery to be achieved when the present invention is applied to a logistics robot.

1. A wheel device for a mobile robot capable of driving on rough terrain and overcoming an obstacle, the wheel device comprising:
a first omni wheel provided in the mobile robot;
a second omni wheel provided in the mobile robot;
a middle wheel provided between the first omni wheel and the second omni wheel;
wheel links connecting the first omni wheel and the middle wheel;
a first suspension connected between the mobile robot and the wheel links; and
a second suspension connected between the mobile robot and the wheel links in the vicinity of the first suspension.

2. The wheel device according to claim 1,
wherein the first omni wheel and the second omni wheel have a plurality of omni wheel segments which are arranged in a circumferential direction.

3. The wheel device according to claim 2,
wherein, of the omni wheel segments, five to ten segments are arranged in the circumferential direction.

4. The wheel device for a mobile robot according to claim 1,
wherein the first omni wheel is a driving wheel.

5. The wheel device according to claim 1,
wherein the middle wheel is a driving wheel.

6. The wheel device according to claim 1,
wherein the first and second suspensions are installed to be relatively rotatable with respect to the mobile robot and the wheel links.

7. The wheel device according to claim 1,
wherein the first and second omni wheels, the wheel links, and the first and second suspensions are provided on both respective sides of the mobile robot.

8. A mobile robot including the wheel device according to claim 1.

9. The mobile robot according to claim 8,
wherein the mobile robot is one of a logistics robot, an electric cart, an automated guided vehicle, and a wheelchair.
